(19) United States
(12) Patent Application Publication
(10) Pub. No.: US 2005/0172827 A1
(43) Pub. Date: Aug. 11, 2005

(54) Air vent unit for household bean milk and bean curd makers

(76) Inventor: Hong-bae Kim, Koyang-city (KR)

Correspondence Address: SHLESINGER, ARKWRIGHT & GARVEY LLP;Suite 600, 1420 King Street, Alexandria, VA, 22314, US

(21) Appl. No.: 10/960,760

(22) Filed: Oct. 8, 2004

(30) Foreign Application Priority Data
Oct. 8, 2003 (KR) 2003-31675

(51) Int. Cl. A23L 1/20

(52) U.S. Cl. 99/348

(57) ABSTRACT

Disclosed herein is an air vent unit for household bean milk and bean curd makers. The household bean milk and bean curd maker includes a housing defining a cavity therein, and a main body provided on an upper portion of the housing to open or close the housing. The air vent unit has a raised part at a predetermined position on an upper surface of the main body. The air vent unit also includes a filter, and a plurality of bars and holes that are alternately formed in the raised part. In this case, the bars function to prevent foreign materials from entering the main body, and the holes function to discharge steam from the main body. The filter is attached to a lower portion of the raised part. The present invention prevents foreign materials from undesirably entering the main body through the air vent unit, and allows a user to easily confirm the position of the air vent unit.

### CROSS-REFERENCE TO RELATED APPLICATION

This application claims priority of Korean application no. 2003-31675, filed Oct. 8, 2003, which is incorporated herein by reference.

This application relates to Applicant's concurrently filed U.S. application (applicant's ref. no. 7400), entitled “Household Bean Milk and Bean Curd Makers with Steam Discharge Function”, filed Oct. 8, 2004.

### FIELD OF THE INVENTION

The present invention relates generally to household bean milk and bean curd makers and, more particularly, to an air vent unit for the household bean milk and bean curd makers, which is constructed to prevent foreign materials from undesirably entering the main body through the air vent unit of a household bean milk and bean curd maker, and to allow a user to easily confirm the position of the air vent unit.

### BACKGROUND OF THE INVENTION

A conventional method of making bean milk and bean curd has a problem in that several processes are individually executed, thus it is inconvenient and complicated to make bean milk and bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 225772, Korean Patent No. 228659, Korean U.M. Registration No. 158856, Korean U.M. Registration No. 250843, etc, that are disclosed by the applicant of the present invention. The Korean Patent No. 225772 was published on Oct. 15, 1999, and is titled “household bean curd maker”. The Korean Patent No. 2000-228659 was published on Mar. 15, 2000, and is titled “household bean curd maker”. The Korean U.M. Registration No. 158856 was registered on Jul. 16, 1999, and is titled “household bean curd maker”. The Korean U.M. Registration No. 250843 was registered on Oct. 5, 2001, and is titled “household bean curd maker with fixed-type blade unit”.

A conventional household bean milk and bean curd maker will be described in the following with reference to the attached drawing.

FIG. 1 is a sectional view of the conventional household bean milk and bean curd maker. As shown in FIG. 1, the conventional household bean milk and bean curd maker includes a housing 1 which has a cavity to contain water therein. A main body 2 is provided on an upper portion of the housing 1 to open or close the housing 1, like a lid. A drive motor 3 is installed in a predetermined portion of the main body 2, and generates rotating power when electricity is applied to the drive motor 3. A drive shaft 4 transmits the rotating power from the drive motor 3. A cutting blade 5 is provided at an end of the drive shaft 4. A rod-shaped heater 6 downwardly extends from the main body 2, and generates heat when electricity is applied to the heater 6, thus heating an interior of the housing 1. A temperature sensing bar 7 detects the temperature of the interior of the housing 1. A filter net 8 is detachably mounted to a predetermined portion of the main body 2, and contains beans therein.

The conventional household bean milk and bean curd maker constructed as described above is operated as follows.

First, a user puts water into the housing 1. Beans are put into the filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate the heater 6 and the temperature sensing bar 7. At this time, a primary heating process is executed while maintaining a predetermined temperature, for a predetermined period.

When the primary heating process has been completed, the control unit (not shown) outputs a control signal to operate the drive motor 3. As the drive motor 3 is operated, the beans contained in the filter net 8 are ground by the cutting blade 5 provided at the end of the drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

An air vent unit 21 is provided on an upper portion of the main body 2 to discharge heat, which is generated from several components including the drive motor 3 installed in the main body 2, to the atmosphere, thus protecting several components installed in the main body 2.

However, the conventional household bean milk and bean curd maker has a problem in that the structure of the air vent unit 21, provided on the upper portion of the main body 2, is inefficient, so that foreign materials may easily enter the main body 2 through the air vent unit 21 when washing the maker.

### OBJECTS AND SUMMARY OF THE INVENTION

Accordingly, the present invention has been made keeping in mind the above problems occurring in the prior art, and an object of the present invention is to provide an air vent unit for household bean milk and bean curd makers, which is constructed to prevent foreign materials from undesirably entering the main body through the air vent unit of a household bean milk and bean curd maker, and to allow a user to easily confirm the position of the air vent unit.

### BRIEF DESCRIPTION OF THE DRAWINGS

FIG. 1 is a sectional view of a conventional household bean milk and bean curd maker;

FIG. 2 is a perspective view to show a household bean milk and bean curd maker having an air vent unit, according to the first embodiment of the present invention;

FIG. 3 is an enlarged view of the air vent unit for the household bean milk and bean curd maker, according to the first embodiment of the present invention;

FIG. 4 is a sectional view taken along line A-A of FIG. 3; and

FIG. 5 is a sectional view of an air vent unit for household bean milk and bean curd makers, according to the second embodiment of the present invention.

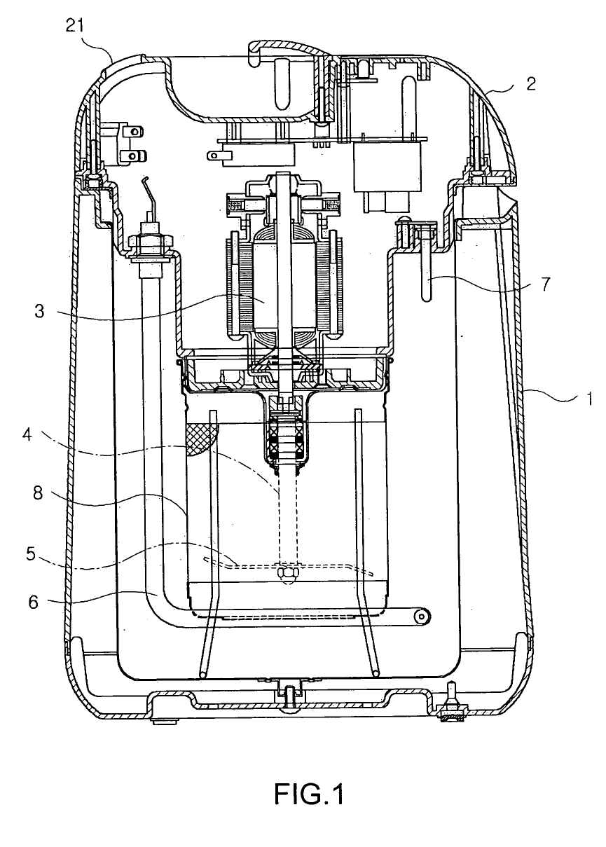

### DETAILED DESCRIPTION OF THE INVENTION

Hereinafter, preferred embodiments of the present invention will be described in detail with reference to the attached drawings so that those skilled in the art may easily implement this invention. The above and other objects, features and other advantages of the present invention will be more clearly understood from the following detailed description.

Since the preferred embodiments of the present invention have been disclosed for illustrative purposes, those skilled in the art will appreciate that various modifications, additions and substitutions are possible, without departing from the scope and spirit of the invention as disclosed in the accompanying claims.

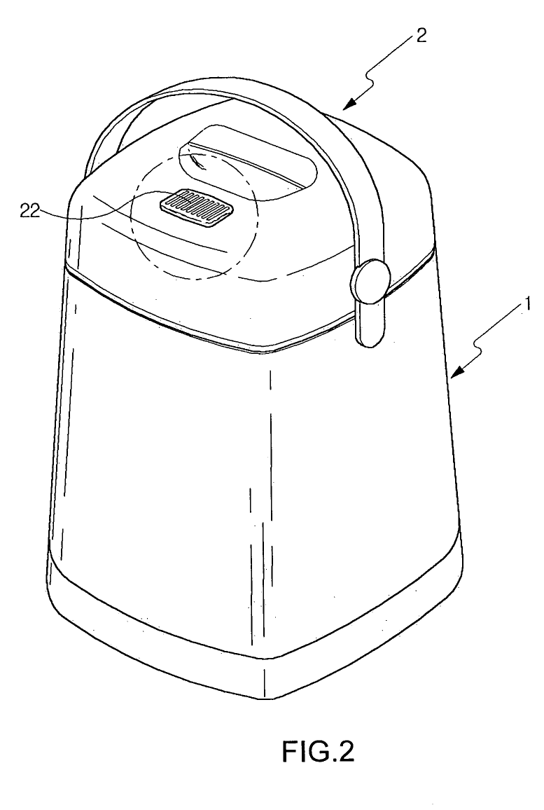

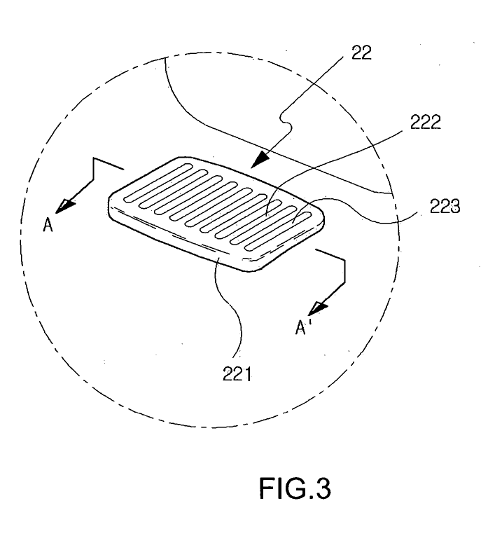

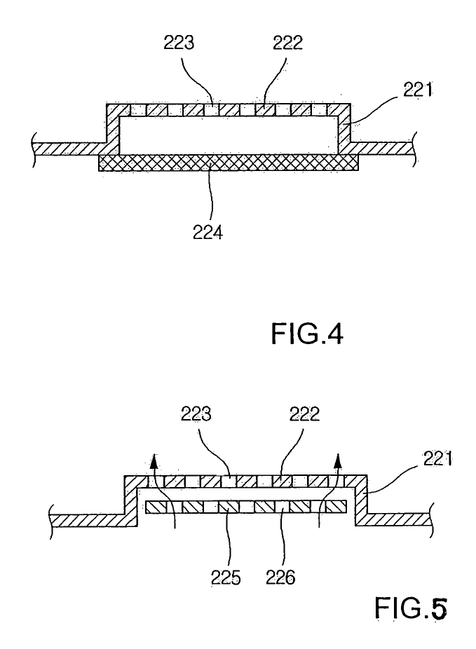

An air vent unit for household bean milk and bean curd makers according to the first embodiment of the present invention is constructed as follows. That is, as shown in FIGS. 2 to 4, the household bean milk and bean curd maker includes a housing 1 and a main body 2. The housing 1 defines a cavity therein. The main body 2 is provided on an upper portion of the housing 1 to open or close the housing 1, like a lid. The household bean milk and bean curd maker also includes an air vent unit 22. The air vent unit 22 has a raised part 221 at a predetermined position on an upper surface of the main body 2. The air vent unit 22 also has a plurality of bars 222 and holes 223 which are alternately formed in the raised part 221. In this case, the bars 222 function to prevent foreign materials from entering the main body 2. The holes 223 function to discharge steam from the main body 2. Further, a filter 224 is attached to a lower portion of the raised part 221.

The operation of the household bean milk and bean curd maker constructed as described above is as follows.

First, a user puts water into the housing 1. Beans are put into a filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate a heater 6 and a temperature sensing bar 7. At this time, a primary heating process is executed while maintaining a predetermined temperature, for a predetermined period.

When the primary heating process has been completed, the control unit (not shown) outputs a control signal to operate a drive motor 3. As the drive motor 3 is operated, the beans contained in the filter net 8 are ground by a cutting blade 5 provided at the end of a drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

In the process of making the bean milk or bean curd, heat is generated from several electric components provided in the main body 2, including the heater 6 and the drive motor 3. The heat is transmitted to air circulating through the air vent unit 22 provided at the upper portion of the main body 2, and is thus emitted to the outside. Such a construction protects the components from heat.

The air vent unit 22 has the holes 223, thus allowing air in the main body 2 to be discharged to the outside. Further, the air vent unit 22 is provided with the bars 222 as well as the raised part 221, thus preventing foreign materials from entering the main body 2.

In addition to the raised part 221 and the bars 222, the filter 224 is attached to the lower portion of the raised part 221, thus filtering foreign materials entering the main body 2 while discharging air in the main body 2 to the outside.

Further, the air vent unit 22 is provided with the raised part 221 and the bars 222, thus allowing a user to easily confirm the position of the air vent unit 22.

An air vent unit for household bean milk and bean curd makers according to the second embodiment of the present invention is constructed as follows. As shown in FIG. 5, the household bean milk and bean curd maker includes a housing 1 and a main body 2. The housing 1 defines a cavity therein. The main body 2 is provided on an upper portion of the housing 1 to open or close the housing 1, like a lid. The household bean milk and bean curd maker also includes an air vent unit 22. The air vent unit 22 has a raised part 221 at a predetermined position on an upper surface of the main body 2. The air vent unit 22 further includes bars 222 and 225 to prevent foreign materials from entering the main body 2, and holes 223 and 226 to discharge steam from the main body 2. The bars 222 and 225 and the holes 223 and 226 have a double-layer structure. In this case, the bars 222 and 225 are formed in the raised part 221 such that they are offset from each other. Similarly, the holes 223 and 226 are formed in the raised part 221 such that they are offset from each other.

The general construction of the air vent unit for the household bean milk and bean curd maker according to the second embodiment is equal to that of the air vent unit for the household bean milk and bean curd maker according to the first embodiment shown in FIGS. 2 to 4, except that the air vent unit of the second embodiment is provided with the bars 225 and the holes 226, in place of the filter 224 of the first embodiment. Thus, a detailed description of the operation of the household bean milk and bean curd maker according to the second embodiment will be omitted herein.

As described above, the present invention prevents foreign materials from undesirably entering a main body through an air vent unit, and allows a user to easily confirm the position of the air vent unit.

While this invention has been described as having a preferred design, it is understood that it is capable of further modifications, and uses and/or adaptations of the invention and including such departures from the present disclosure as come within the known customary practice in the art to which the invention pertains, and as may be applied to the central features hereinbefore set forth, and fall within the scope of the invention or limits of the claims appended hereto.

1. An air vent unit for household bean milk and bean curd makers each having a housing defining a cavity therein, and a main body provided on an upper portion of the housing to open or close the housing, the air vent unit comprising:
a) a raised part formed at a predetermined position on an upper surface of the main body;
b) a plurality of bars and holes that are alternately formed in the raised part, the bars functioning to prevent foreign materials from entering the main body, and the holes functioning to discharge steam from the main body; and
c) a filter attached to a lower portion of the raised part.

2. An air vent unit for household bean milk and bean curd makers each having a housing defining a cavity therein, and a main body provided on an upper portion of the housing to open or close the housing, the air vent unit comprising:
a) a raised part formed at a predetermined position on an upper surface of the main body;
b) a plurality of bars to prevent foreign materials from entering the main body, the bars being formed in the raised part such that the bars are offset from each other while forming a double-layer structure; and
c) a plurality of holes to discharge steam from the main body, the holes being formed in the raised part such that the holes are offset from each other while forming a double-layer structure.
